(19) United States
(12) Patent Application Publication
(10) Pub. No.: US 2008/0251310 A1
(43) Pub. Date: Oct. 16, 2008

(54) Vehicle Steering System

(76) Inventors: Axel Hinz, Neu-Anspach (DE); Gunther Vogel, Dreieich (DE); Daniela Zuk, Wiesbaden (DE)

Correspondence Address: CONTINENTAL TEVES, INC., ONE CONTINENTAL DRIVE, AUBURN HILLLS, MI, 48326-1581, US

(21) Appl. No.: 11/666,965

(22) PCT Filed: Nov. 4, 2005
(86) PCT No.: PCT/EP05/55764

§ 371 Date: Mar. 13, 2008

(30) Foreign Application Priority Data
Nov. 4, 2004 (DE) 10 2004 053 252.4

(51) Int. Cl. B62D 5/08

(52) U.S. Cl. 180/432

(57) ABSTRACT

A vehicle steering system for motor vehicles has a steering handle operable by the driver and connected to steerable vehicle wheels in terms of effect to determine a direction of driving. The vehicle steering system includes a hydraulic working cylinder having two directions of effect, as well as a hydraulic pressure source, which applies hydraulic pressure to a valve assembly. The valve assembly controls the magnitude of the hydraulic pressure conveyed to the working cylinder and determines the direction of effect of the working cylinder. The valve assembly has two separated valves, the first valve determining the direction of effect of the working cylinder, while the second valve controls the working pressure for the hydraulic working cylinder.

### BACKGROUND OF THE INVENTION

The present invention relates to a vehicle steering system and a method of operating a vehicle steering system.

Up-to-date motor vehicles, especially passenger vehicles, are generally equipped with hydraulic or electrohydraulic power steering systems, in which a steering wheel is coupled mechanically to the steerable vehicle wheels in a forced way. The servo aid of the vehicle steering system usually includes actuators such as hydraulic cylinders in the mid-portion of the steering mechanism. A force generated by the actuators supports the operation of the steering mechanism as a reaction to the rotation of the steering wheel induced by the driver. This reduces the expenditure of force of the driver during the steering operation.

A slide valve of analog control is provided in prior art vehicle steering systems, which regulates both the direction of effect of the servo cylinder and the amount of the servo pressure. The slide valve is configured as a rotary slide valve, in which the slide is positioned by way of a stroke magnet and/or an electric motor with a reduction gear in such a fashion that the desired dynamic pressure develops in the amount desired in the desired cylinder chamber at the servo cylinder. The necessary rotary slide valves are relatively complex and necessitate great effort in manufacture.

Based on the above, an object of the invention involves providing an alternative vehicle steering system.

### SUMMARY OF THE INVENTION

This object is achieved by a vehicle steering system with a steering handle operable by the driver and connected to steerable vehicle wheels in terms of effect to determine a direction of driving. The vehicle steering system comprises a hydraulic working cylinder having two directions of effect, as well as a hydraulic pressure source, which applies hydraulic pressure to a valve assembly. The valve assembly controls the magnitude of the hydraulic pressure conveyed to the working cylinder and determines the direction of effect of the working cylinder. The valve assembly comprises two separated valves, the first valve determining the direction of effect of the working cylinder, while the second valve controls the working pressure for the hydraulic working cylinder.

In an embodiment of the invention, the first valve is configured as a digitally controllable electromagnetic slide valve. In another embodiment of the invention, the first valve is an electromagnetic slide valve of analog control.

The first slide valve exhibits a variable switching speed in a favorable improvement. The variable switching speed is favorable to achieve smooth switching operations.

In an expedient embodiment, the slide of the first valve constitutes a hydraulic short-circuit between the two cylinder chambers of the working cylinder when switching over from the one direction of effect of the working cylinder to the other one. The hydraulic short-circuit enhances the steering comfort for the driver.

In a favorable embodiment of the vehicle steering system of the invention, a steering unit is provided that receives signals from a steering angle sensor and a steering torque sensor and derives control commands therefrom, which are sent to the valve assembly.

In another embodiment of the invention, the second valve is a slide valve of analog control. A travel sensor can be provided in this case, which senses the position of the slide of the second valve and transmits a corresponding position signal to the control unit.

Suitably, the pressure source can be a pump that supplies a hydraulic medium from a reservoir and applies the hydraulic medium to the valve assembly.

A favorable embodiment of the invention arranges for a safety valve, which establishes a hydraulic short-circuit between the cylinder chambers of the working cylinder in the event of a malfunction. The safety valve can be an electromagnetic valve, which is preloaded by a mechanical spring to assume the hydraulic short-circuit position.

In an appropriate improvement of the vehicle steering system of the invention, at least three pressure sensors are provided, two of them measuring the same pressure in normal operation. The advantage of the configuration is that certain operating troubles are detected quickly and simply in case two of the pressure sensors do not indicate the same pressure.

Another objective of the invention relates to providing a method to operate a vehicle steering system of the type described hereinabove.

According to the invention, this object is achieved by a method of operating a hydraulic vehicle steering system, comprising the following steps:

apply hydraulic pressure medium optionally to the cylinder chambers of a working cylinder;

keep a safety valve closed in opposition to the force of a mechanical spring when steering force is requested from the working cylinder; and

open the safety valve when steering force is not requested from the working cylinder or when malfunction is detected.

Embodiments of the invention are illustrated in the drawings. Like or corresponding parts have been designated by identical reference numerals.

### BRIEF DESCRIPTION OF THE DRAWINGS

In the accompanying drawings:

FIG. 1 is a schematic view of a vehicle steering system of the invention;

FIG. 2a shows a hydraulic circuit diagram of a first embodiment of the vehicle steering system of the invention;

FIG. 2b shows a hydraulic circuit diagram of a second embodiment of the vehicle steering system of the invention;

FIG. 2c shows a hydraulic circuit diagram of a third embodiment of the vehicle steering system of the invention;

FIG. 3a shows a specific development of the third embodiment of the vehicle steering system of FIG. 2c;

FIG. 3b shows another specific development of the third embodiment of the vehicle steering system of FIG. 2c;

FIG. 3c shows a third specific development of the third embodiment of FIG. 2c.

### DETAILED DESCRIPTION OF THE DRAWINGS

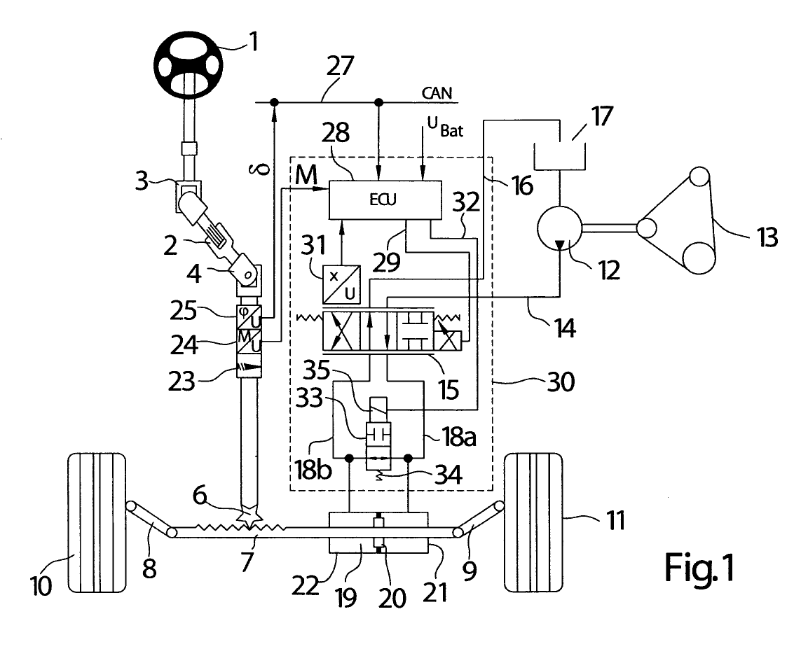

The steering system illustrated in FIG. 1 comprises a steering wheel 1 and a steering column 2, which is connected to the steering wheel 1 and has two universal joints 3, 4. The steering column 2 is connected to a steering wheel shaft 5 or forms part of the steering wheel shaft 5. The steering wheel shaft 5 drives a steering gear 6, converting the rotation of the steering wheel shaft 5 into a translational motion of a steering rod 7. In FIG. 1, the steering rod 7 is configured as toothed rack 7 operating the tie rods 8, 9 arranged at the steering rod 7. The actuation of the tie rods 8, 9 causes wheels 10, 11 to deviate in order to steer the direction of travel of the vehicle. In the rack-and-pinion steering system (as shown herein), hydraulic aid is realized by means of a hydraulic pump 12 that is driven by means of the driving motor of the vehicle. Pump 12 is driven by way of a belt drive 13 in the illustrated embodiment. Of course, all other appropriate driving means known from the state of the art are also feasible in order to realize the invention at issue. Hydraulic pump 12 produces pressure in a hydraulic fluid, which is fed through a conduit 14 to a directional control valve 15. The pressure fluid can flow back into a supply reservoir 17 by way of a return conduit 16. The directional control valve 15 is connected to a hydraulic working cylinder 19 by way of two hydraulic conduits 18a, 18b. A piston 20 subdivides the working cylinder 19 into two cylinder chambers 21, 22.

Piston 20 is immovably seated on the steering rod 7 allowing the piston 20 to exert a force directly to the steering rod 7 when excess pressure is applied to one of the two cylinder chambers 21, 22.

A torsion rod 23, a torque sensor 24, and an angle sensor 25 are arranged between the second universal joint 4 and the steering gear 6. The angle sensor 25 measures the angle of rotation predetermined by a driver using the steering wheel 1 and outputs an output signal δ representative of the angle of rotation. The output signal δ is transmitted by way of a vehicle bus (CAN) 27 and is sent to a central control unit (ECU) 28. The vehicle bus transmits the output signal δ, for example, also to a driving stability control, which is not shown in FIG. 1 and is not the subject matter of the invention. The torque sensor 24 measures the torque exerted by the driver and sends an output signal M that is representative of the torque to the control unit 28.

Eventually, the electronic control unit 28 also receives a signal U_{Bat} representative of the battery voltage in order to disregard a fault report by steering, that means, the battery voltage drops below a threshold value and the proper function of the vehicle steering system is ensured no longer. The effect of a fault report is that the safety valve 33 switches off and a hydraulic short-circuit is established between the cylinder chambers 21, 22, which deactivates the hydraulic steering aid.

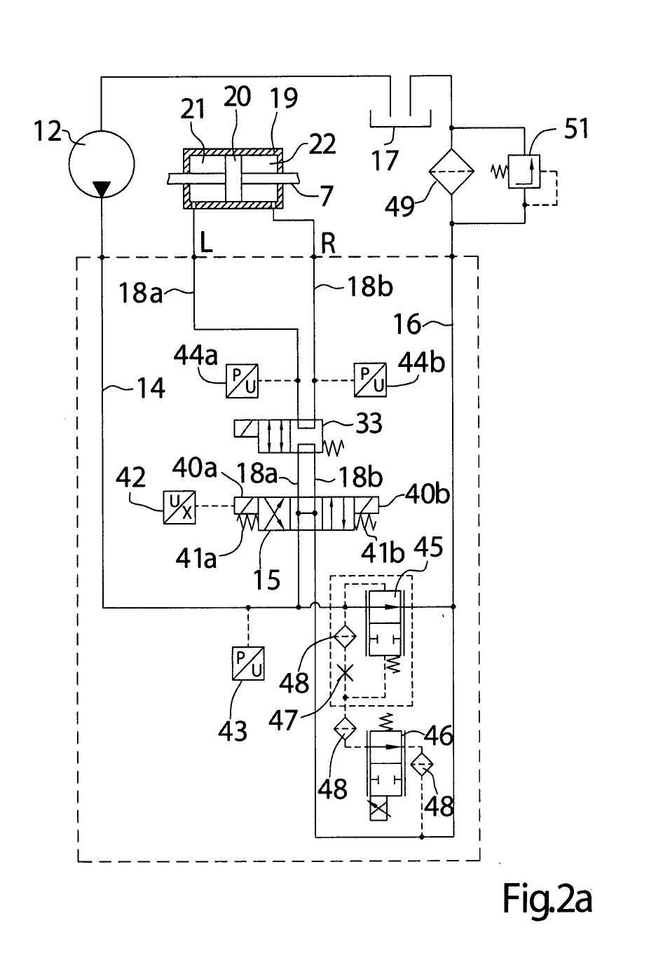

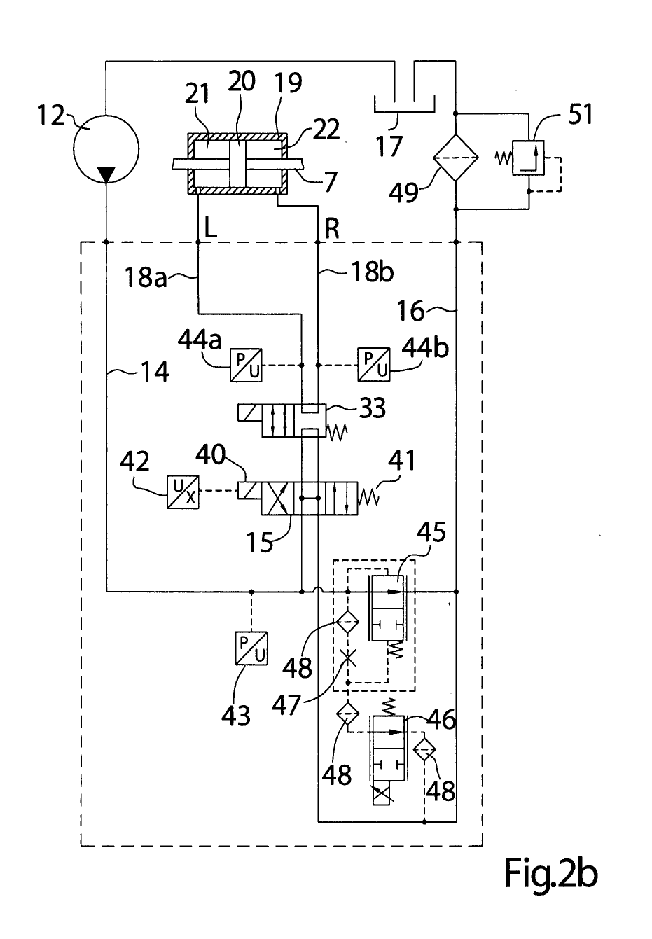

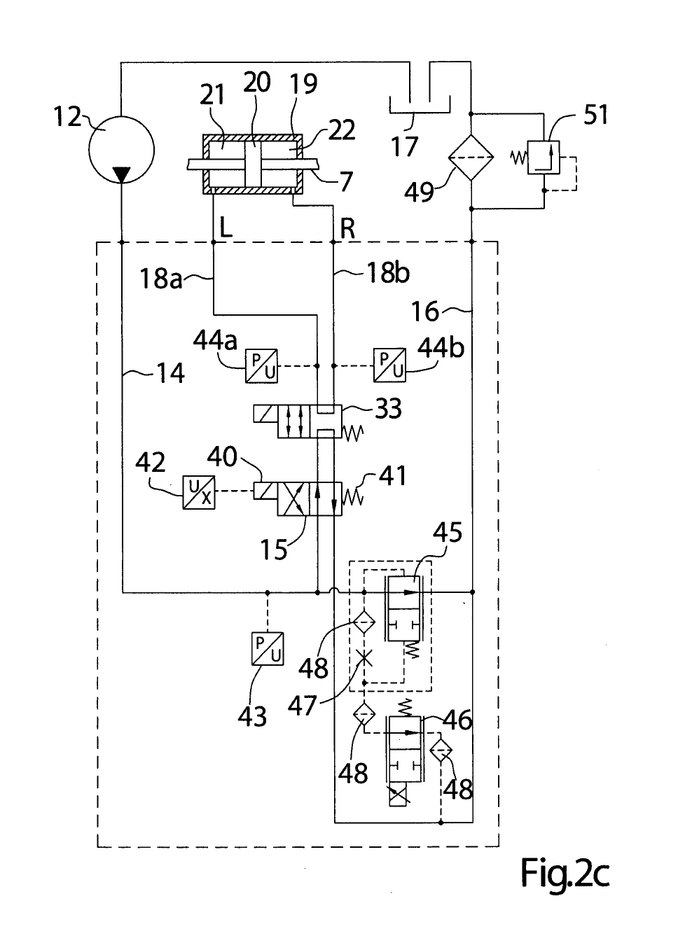

A control conduit 29 leads from the control unit 28 to the directional control valve 15 in order to determine the direction of the steering aid, that means, which one of the two cylinder chambers 21, 22 is acted upon by pressure fluid. In addition, a slide valve 45 (FIG. 2) not illustrated in FIG. 1 fixes the magnitude travel of the working pressure, i.e. the rate of the steering aid. Sensor 31 measures the position of the slide in the directional control valve 15, and the output signal of the sensor is fed back to the control unit 28 in order to close a control circuit.

A second control conduit 32 connects the control unit 28 to a safety valve 33. In the event of system failure, the safety valve 33 establishes a hydraulic short-circuit between the two cylinder chambers 21, 22 of the working cylinder 19. This fact safeguards that the vehicle remains steerable due to the mechanical coupling between the steering wheel 1 and the steering rod 7. The hydraulic short-circuit between the cylinder chambers 21, 22 ensures that the piston 20 and, thus, the steering rod is displaceable.

The safety valve 33 is configured in such a way that it is preloaded by a mechanical spring 34 to adopt the short-circuit position shown in FIG. 1. An electromagnet 35 works in opposition to spring pressure and closes the safety valve 33 when a corresponding current flows through the winding of the electromagnet. When the control unit 28 switches off the current, or when the current fails, the safety valve 33 will automatically return to the short-circuit position, whereby steerability of the vehicle is guaranteed.

The subassembly, which regulates the amount and the direction of the working pressure, including the safety valve 33, is briefly referred to as valve assembly 30 and is drawn by a broken line in FIG. 1.

FIG. 2a shows a hydraulic circuit diagram of the vehicle steering system illustrated in FIG. 1. Pump 12 aspirates hydraulic fluid from the reservoir 17 and delivers it with increased pressure through the conduit 14 to the directional control valve 15. The directional control valve 15 in FIG. 2a is a solenoid valve with two stroke magnets 40a, 40b arranged on either side and counteracting two springs 41a, 41b also arranged on either side. Thus, the directional control valve 15 is spring-centered. When both magnets 40a, 40b are switched to their de-energized condition, the slide of the directional control valve 15 (direction slide) will adopt the mid-position illustrated in FIG. 2a, in which the four ports of the valve are hydraulically short-circuited in pairs. When one of the two stroke magnets is activated, the ports of the valve 15 are rendered open directly or crosswise, respectively. The position of the slide is monitored by means of a travel sensor 31, whose output signal is transmitted to the control unit 28.

In an alternative embodiment, a travel switch monitoring the position of the direction slide can be a substitute for the travel sensor 31.

The hydraulic conduits 18a and 18b connect two of the ports of the directional control valve 15 to the left or right cylinder chamber 21, 22 of the working cylinder 19, respectively. Interposed between the cylinder chambers 21, 22 and the directional control valve 15 is the safety valve 33, its mode of function has been explained already with respect to FIG. 1.

The magnitude of the pressure in the pressure conduit 14 is measured by means of a pressure sensor 43. In addition, one pressure sensor 44a, 44b each is arranged in the two supply conduits 18a, 18b to the two cylinder chambers 21, 22. The illustrated arrangement of the three pressure sensors 43, 44a and 44b allows effectively monitoring the proper functioning of the valves 15 and 33. In the event of proper functioning of the valves 15, 33, two of the three pressure sensors always measure the same pressure: When the cylinder chamber 21 is pressurized, the pressure sensors 43 and 44a measure the same pressure. The pressure sensor 44b connected to the bled cylinder chamber 22 accordingly measures a lower pressure. If, on the other hand, the cylinder chamber 22 is pressurized, the pressure sensors 43 and 44b measure the same pressure. The pressure sensor 44a, which connects to the cylinder chamber 21 that is bled at that time, accordingly measures a lower pressure. The output signals of the pressure sensors 43, 44a and 44b are transmitted to the control unit 28, where they are evaluated.

The control unit 28 assesses test values, which differ from this pattern, as a malfunction. A possible reaction to the malfunction is the deactivation of the hydraulic steering aid, the safety valve 33 short-circuiting the conduits 18a, 18b. The short-circuit renders the hydraulic cylinder 19 inoperative, as has been described in connection with FIG. 1. In an embodiment of the invention, it is arranged for that the pressure measurements are repeated before the results of the measurements are assessed.

A slide valve 45 adjusts the magnitude of the pressure. The slide valve is pilot-operated by an analogized solenoid valve 46, that means the slide of the valve 45 is operated hydraulically, and the operating pressure is adjusted by the solenoid valve 46. The pressure gradient between the supply conduit 14 and the return conduit 16 for the hydraulic fluid is utilized. A flow limitation means 47 and filter 48 are arranged in the connecting conduits between the valves 45 and 46 in order to avoid abrupt pressure changes, for example.

A magnet drives the slide valve 45 in an alternative embodiment. This embodiment, exactly as the hydraulically pilot-operated valve 45, allows continuously changing the valve slide position in order to render a continuous variation of the working pressure possible. The return conduit 16 also accommodates a flow filter 49 with which a pressure limiting valve 51 is connected in parallel as a bypass valve.

FIG. 2b illustrates a hydraulic circuit diagram of a modified embodiment of the vehicle steering system of the invention. The difference over the embodiment illustrated in FIG. 2a can be seen in the design of the directional control valve 15. In the embodiment of FIG. 2b, the directional control valve includes a stroke magnet 40 arranged on one side and counteracting a spring 41. However, the directional control valve 15 in FIG. 2b, exactly as the directional control valve 15 in FIG. 2a, has a mid-position in which a short-circuit between the two cylinder chambers 21, 22 of the working cylinder 19 is established when the directional control valve changes the direction of effect of the working cylinder 19. Compared to the embodiment illustrated in FIG. 2a, only one single connector plug for the stroke magnet must be provided for the directional control valve 15 in FIG. 2b, what is advantageous in terms of costs.

FIG. 2c shows the hydraulic circuit diagram of another embodiment of the vehicle steering system of the invention. Like in the embodiment of FIG. 2b, the directional control valve 15 has only one single stroke magnet 40 counteracting a spring 41. In contrast to the embodiment of FIG. 2b, the hydraulic short-circuit is, however, not achieved with a separate switch position when changing over the directional control valve. Rather, the control edges at the slide in the directional control valve 15 of FIG. 2c are smaller than the diameter of the supply bores of the sleeve, so that the desired hydraulic short-circuit between the cylinder chambers 21 and 22 of the working cylinder 29 develops for a short time when the slide changes from one position to the other position. The directional control valve illustrated in FIG. 2c is less complicated than the directional control valves depicted in FIGS. 2a and 2b.

The embodiment shown in FIG. 2c is particularly favorable because the direction slide does not exhibit a separate mid-position and, therefore, can be designed in a very simple and short fashion. However, the inevitable dynamic pressure at the pressure control valve would cause an unwanted force to develop at the working cylinder 19 in the preferential direction, that means when the switching magnet is not energized, what lasts as long as the safety valve 33 is enabled. This is why the safety valve 33 in this embodiment is always disabled when steering aid is not required. This mode of operation also has a positive effect on the thermal economy of the electronic unit. The corresponding operating method represents the second aspect of the invention at issue.

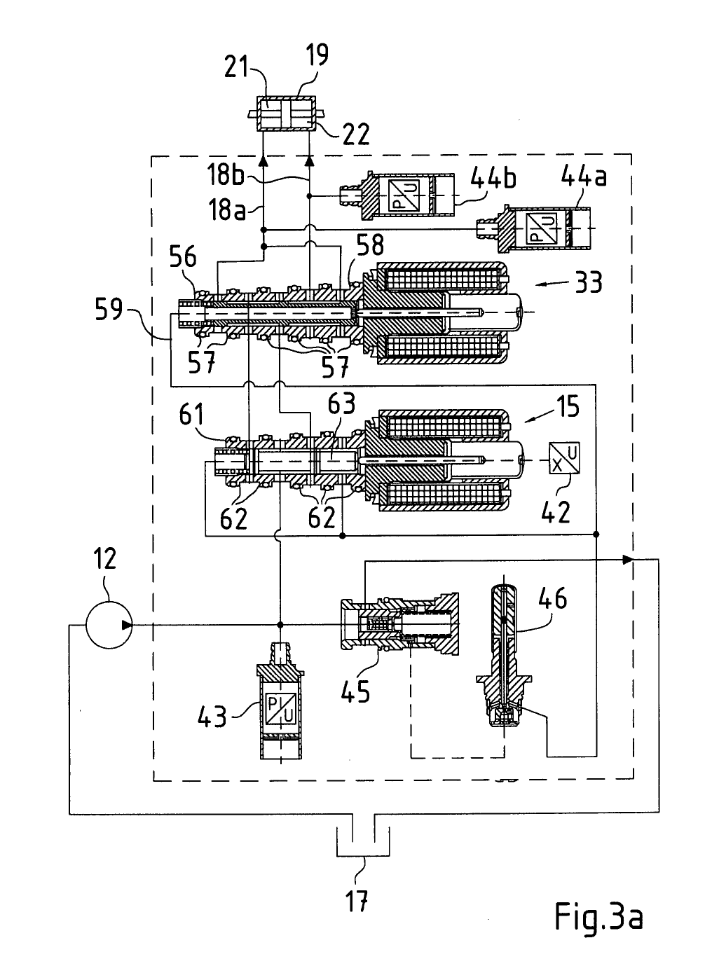

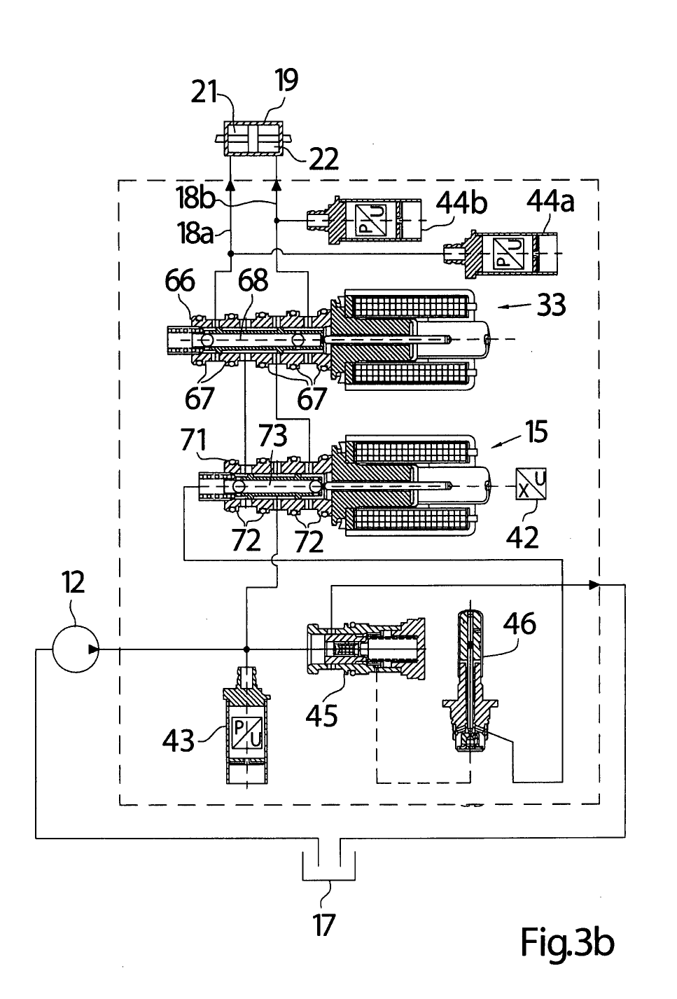

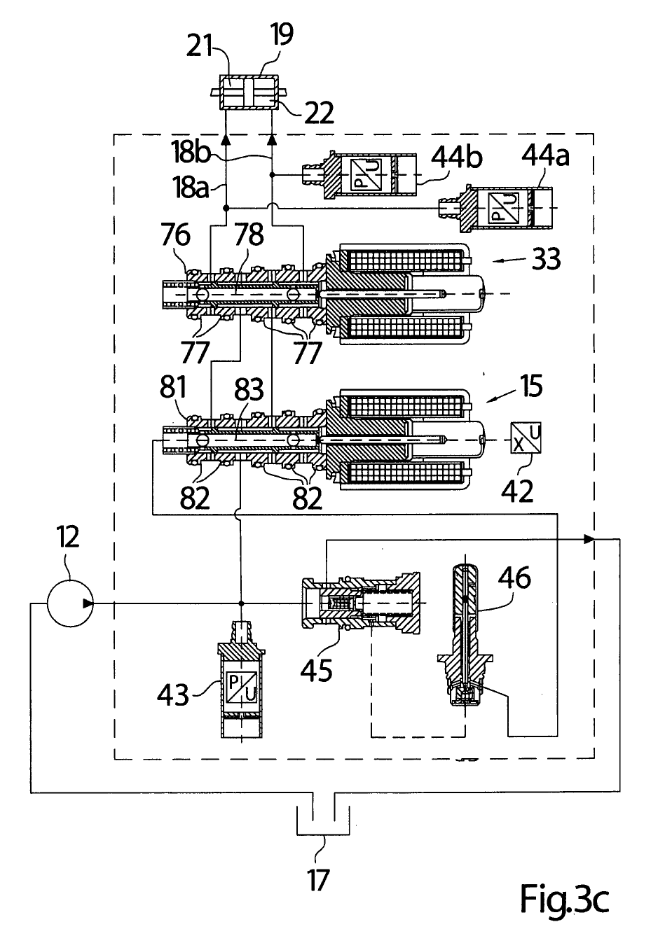

FIG. 3a shows a specific embodiment for the hydraulic circuit diagram displayed in FIG. 2c. The safety valve 33 includes a sleeve 56 with six steps 57 in the embodiment illustrated in FIG. 3a. Further, the safety valve 33 includes a hollow piston 58 without transverse bores. A separate reservoir port 59 takes care of the pressure compensation in the safety valve 33. The safety valve is not capable of mini-clinching.

The directional control valve 15 includes a nozzle 61 with five steps 62 as well as a piston 63 configured as a solid member. The directional control valve 15 is capable of mini-clinching.

FIG. 3b displays another specific development for the hydraulic circuit diagram shown in FIG. 2c. In this embodiment, the safety valve 33 includes a sleeve 66 with five steps 67. The safety valve 33 is furnished with a hollow piston 68 including transverse bores. However, pressure compensation by separate reservoir ports is not provided.

The directional control valve 15 includes a sleeve 71 with four steps 72 and a hollow piston 73 having transverse bores. The directional control valve 15 is suitable for mini-clinching.

Ultimately, FIG. 3c illustrates a last specific embodiment for the hydraulic circuit diagram shown in FIG. 2c. In this embodiment, the directional control valve 15 and the safety valve 33 are configured in such a manner that sleeves and pistons are respectively designed as equal components. In particular, the sleeves are furnished with five steps. The pistons are hollow and include transverse bores. Both valves 15, 33 are fit for mini-clinching. No pressure compensation by separate reservoir ports is provided for the safety valve 33.

1.-13. (canceled)

14. A vehicle steering system for motor vehicles with a steering handle (1) being operable by the driver and connected to steerable vehicle wheels (10, 11) in terms of effect to determine a direction of driving, comprising a hydraulic working cylinder (19) having two directions of effect and two cylinder chambers (21,22), a hydraulic pressure source (12), which applies hydraulic pressure to a valve assembly (30), the valve assembly (30) controlling the magnitude of the hydraulic pressure conveyed to the working cylinder (19) and determining the direction of effect of the working cylinder,
wherein the valve assembly (30) comprises two separated valves (15, 45), the first valve (15) determining the direction of effect of the working cylinder, while the second valve (45) controls the working pressure for the hydraulic working cylinder.

15. The vehicle steering system as claimed in claim 14,
wherein the first valve (15) is configured as a digitally controllable electromagnetic slide valve.

16. The vehicle steering system as claimed in claim 14,
wherein the first valve (15) is an electromagnetic slide valve of analog control.

17. The vehicle steering system as claimed in claim 16,
wherein the first slide valve (15) exhibits a variable switching speed.

18. The vehicle steering system as claimed in claim 14,
wherein first valve is configured as a slide valve and the slide of the first valve (15) constitutes a hydraulic short-circuit between the two cylinder chambers of the working cylinder (19) when switching over from the one direction of effect of the working cylinder to the other one.

19. The vehicle steering system as claimed in claim 14,
wherein the second valve (45) is a slide valve of analog control.

20. The vehicle steering system as claimed in claim 14,
wherein a control unit is provided, which receives signals from a steering angle sensor and from a steering torque sensor and derives therefrom control commands being sent to the valve assembly.

21. The vehicle steering system as claimed in claim 20,
wherein first valve is configured as a slide valve and a travel sensor (31) is provided, which senses the position of the slide of the first valve (15) and transmits a corresponding position signal to the control unit (28).

22. The vehicle steering system as claimed in claim 14,
wherein the pressure source is a pump (12) that supplies hydraulic medium from a reservoir (17) and applies the hydraulic medium to the valve assembly (30).

23. The vehicle steering system as claimed in claim 14,
wherein a safety valve (33) is provided, which establishes a hydraulic short-circuit between the cylinder chambers (21, 22) of the working cylinder (19) in the event of a malfunction.

24. The vehicle steering system as claimed in claim 23,
wherein the safety valve (33) is an electromagnetic valve, which is preloaded by a mechanical spring (34) to assume a position of a hydraulic short-circuit.

25. The vehicle steering system as claimed in claim 23,
wherein at least three pressure sensors (43, 44a, 44b) are provided, two of them always measuring the same pressure during normal operation.

26. A method of operating a hydraulic vehicle steering system, the method comprising the following steps:
applying hydraulic pressure medium optionally to two cylinder chambers (21, 22) of a working cylinder (19);
keeping a safety valve (33) closed in opposition to the force of a mechanical spring when steering force is requested from the working cylinder (19); and
opening the safety valve (33) when steering force is not requested from the working cylinder or when malfunction is detected.
